(19) United States
(12) Patent Application Publication
(10) Pub. No.: US 2014/0289366 A1
(43) Pub. Date: Sep. 25, 2014

(54) SERVICE PROVIDING METHOD AND SYSTEM FOR INSTANCE HOSTING

(71) Applicant: Korea Advanced Institute of Science and Technology, Yseong-gu (KR)

(72) Inventors: Jun Kyun CHOI, Yuseong-gu (KR); Jinhong YANG, Yuseong-gu (KR); Hyo Jin PARK, Yuseong-gu (KR); Yongrok KIM, Jung-gu (KR); Hyo Ju PARK, Yuseong-gu (KR); Dong Yeong KIM, Yesan-gun (KR)

(73) Assignee: Korea Advanced Institute of Science and Technology, Yuseong-gu (KR)

(21) Appl. No.: 14/159,821

(22) Filed: Jan. 21, 2014

(30) Foreign Application Priority Data
Mar. 20, 2013 (KR) 10-2013-0029632
Apr. 5, 2013 (KR) 10-2013-0037492
Apr. 5, 2013 (KR) 10-2013-0037493
May 22, 2013 (KR) 10-2013-0057796

(51) Int. Cl. H04L 29/08

(52) U.S. Cl. CPC H04L 67/10
USPC 709/218

(57) ABSTRACT

A service providing method and system for instance hosting is disclosed. A service providing system including an instance hosting gateway may include: a network adaptor configured to receive data by connecting to at least one physical node over a wired/wireless network; and an instance manager configured to manage at least one process and a profile provided with respect to at least one of a process node deployed in a process form and the physical node, and to connect the received data or data transferred from the process node to at least one instance using the profile and the at least one process.

### CROSS-REFERENCE TO RELATED APPLICATION

This application claims the priority benefit of (1) Korean Patent Application No. 10-2013-0029632, filed on Mar. 20, 2013, (2) Korean Patent Application No. 10-2013-0037492, filed on Apr. 5, 2013, (3) Korean Patent Application No. 10-2013-0037493, filed on Apr. 5, 2013 and (4) Korean Patent Application No. 10-2013-0057796, filed on May 22, 2013, in the Korean Intellectual Property Office, the disclosure of which is incorporated herein by reference.

### BACKGROUND

1. Field of the Invention

Embodiments of the present invention relate to a service providing method and system for instance hosting.

2. Description of the Related Art

Internet of Things (IoT) has been evolved from an existing Ubiquitous Sensor Network (USN) or Machine to Machine (M2M) communication. While the existing M2M communication has primarily aimed at communication between communication equipment, for example, an end device and a person, IoT has enabled communication between a thing, which is generally visible to users, such as a telephone, a book, and a thermometer, and a person by expanding the scope of things. For example, IoT may indicate a machine-and-space connecting network in which three distributed environmental elements, a person, a thing, and a service, cooperatively establish intelligent relationships, such as sensing, networking, and information processing, without explicit intervention of the person.

In addition to such IoT, a variety of concepts and techniques such as Web of Things (WoT) or Web of Objects (WoO) have been studied and developed. With the development and distribution of the concepts and the techniques, a use of devices, for example, gadget devices, sensor devices, and actuators, via which users can easily connect to the Internet, will increase.

In particular, web linkage gadget devices are currently being released in various types. Further, many sensor devices provide a control and monitoring function via a web. Also, terminals to provide a control function via a web may be embedded with a web server function or may include a function that is controllable via an online web service.

However, the aforementioned techniques, devices, and services are individually being managed and thus, a user has inconvenience. For example, even though a user is located around a plurality of devices, the user may need to control each device via an individual access path, for example, a universal resource locator (URL). When a device autonomously provides a web access function, for example, a server function, network linkage and a URL, for example, an Internet Protocol (IP) address for an access of an individual device may be required. In the case of a service that is provided via an exclusive web service, an access right may need to be created for each service and a URL may also be required for each service.

Also, data being individually managed may not be readily used via an organic linkage. For example, in the case of a sensor configured to control a boiler installed in a house, a sensor device may directly gather only limited ambient environment information such as a presence of a person residing in the house, an inside temperature, and a time zone. If the sensor device is capable of additionally using external information, for example, an outside temperature and schedules of a user, a more effective control function may be provided. However, due to data being individually managed for each technique, device, or service, it is difficult to organically link and use the data.

FIG. 1 is a diagram illustrating a service providing method when a device includes an embedded web server according to the related art. A user may access an embedded web server 140 that is embedded in an IoT node 130 of a physical world 120 via an online web 110. Here, the embedded web server 140 is embedded in the IoT node 130 and thus, all of the process logics used to process data created by the IoT node 130 and to process a predetermined function or service are provided to the IoT node 130. Accordingly, it is impossible to provide a service linked to or converged with another service coverage or data of another service at an outside of service coverage provided from the IoT node 130.

FIG. 2 is a diagram illustrating a service providing method when a manufacturer provides a separate online web server according to the related art. Dissimilar to the service providing method of FIG. 1, referring to FIG. 2, a manufacturer or a separate service provider provides a service by constructing a web server 210 via the online web 110. Here, a user may access an IoT node 220 via the web server 210 online. In this case, a module, for example, a Hypertext Transfer Protocol (HTTP) adaptor 230 for communicating with the web server 210 may be included in the IoT node 210. Accordingly, all of the process logics used to process data created by the IoT node 220 and to process a predetermined function or service may be provided online. If necessary, data may exist on the IoT node 210 and a process logic may exist on the web server 210. In this case, issues associated with a web service availability performance of a manufacturer or a separate service provider and lastingness of hosing may arise.

In addition, referring to FIGS. 1 and 2, a user may not access the IoT node 130 including the embedded web service server 140 via the web server 210 and on the contrary, may not access the web server 210 or the IoT node 220 via the embedded web server 140 of the IoT node 130. That is, information cannot be mutually exchanged between object instances and thus, a linkage type or convergence type service may not be provided.

Also, referring to FIG. 2, to provide a service, the IoT node 220 may need to provide the web server 210 with information obtained from a thing, for example, a sensor, or personal information of a user, for example, a location of the user, and thus a privacy of the user may be infringed.

### SUMMARY

An aspect of the present invention provides a service providing method and system that may manage different devices or various services through linkage or convergence therebetween and may provide an integrated service in an Internet of Things (IoT) environment, a Web of Things (WoT) environment, or a Web of Objects (WoO) environment.

According to an aspect of the present invention, there is provided a service providing system including an instance hosting gateway, the system including: a network adaptor configured to receive data by connecting to at least one physical node over a wired/wireless network; and an instance manager configured to manage at least one process and a profile provided with respect to at least one of a process node deployed in a process form and the physical node, and to connect the received data or data transferred from the process node to at least one instance using the profile and the at least one process.

The at least one physical node may be provided to a device connected using at least one of a plurality of network interfaces.

The instance manager may include: a loader configured to call a personal instance to process the at least one process for each instance; and an instance lifecycle controller configured to provide a function of managing a lifecycle of the personal instance.

The instance manager may further include: an updater configured to download information on a profile and a process present outside; and a deployer configured to parse information on the profile and register information on the process.

The instance manager may further include an updater configured to download information on a profile and a process present outside. The updater may be configured to obtain location information of the profile from the at least one node, to obtain the profile based on the location information of the profile, and to obtain information on the profile based on the location information of the process of the at least one node that is included in information on the at least one node included in the profile.

The service providing system may further include a deployer configured to parse information on the profile and register information on the process. The instance manager may be configured to process datastream information received from the at least one node based on information on the process.

The instance manager may further include: a logger configured to log application operation information and input/output of data occurring in the instance manager; a database configured to store data received from the physical node or data transferred from the process node; and a JavaScript engine configured to process JavaScript syntax included in the processes.

The service providing system may further include an instance application server configured to provide a function of interacting with an external service, and to provide a user interface to a user.

The instance application server may include: an Application Program Interface (API) exposure unit configured to provide, to the external service, a function associated with processing the instance in a form of an API for an interaction with the external service; and a management portal configured to provide, to the user, at least one of a user account managing function, an instance managing function, a system managing function, and an API managing function.

The API exposure unit may include: a RESTful management unit configured to provide an input value and an output value of the instance via an interface based on profiles; a feeder configured to provide the output value of the instance in a feed form based on the profiles; and an API trigger configured to trigger an external API, and to transfer, to a corresponding API, a message including an API triggering function.

The instance manager may be configured to load datastream information of the at least one node, and to select one of a RESTful form and the feed form. When the RESTful form is selected, the RESTful management unit may be configured to obtain a user identifier of a user of an instance corresponding to the datastream information and an instance identifier of the datastream information, to create a universal resource locator (URL) of an API for providing the datastream information to an outside based on the user identifier and the instance identifier, and to register the created URL to an instance hosting platform server.

The instance application server may further include: a key generator configured to generate a key for controlling an access authentication for an interaction with external services; and an authenticator configured to provide a function for authentication when interacting with the external services.

The network adaptor may include a message parser configured to parse data received based on a message format for each interwork interface or a message format for each node.

The profile may be created at a service provider server based on information provided from a developer of the at least one node, and may be stored and thereby managed in an IoT profile database included in the service provider server or may be provided to the developer. The at least one node may be registered to the instance hosting gateway using the profile stored in the IoT profile database, the profile provided to the developer and thereby provided through a URL associated with the developer, or the profile provided to the developer and thereby included in the at least one node.

The service providing system may further include: an IoT profile receiver configured to receive the profile of the at least one node through the at least node requesting an access, a URL associated with a developer of the at least one node, or an IoT profile database of a service provider server that creates the profile of the at least one node; and an IoT node register configured to register the at least one node requesting the access based on the profile. The profile may be created by the service provider server based on information on the at least one node provided from the developer of the at least one node and a predetermined eXtensible Markup Language (XML) schema definition.

According to another aspect of the present invention, there is provided a service providing system, including: a first network adaptor configured to receive data from nodes by connecting to a node including an embedded web server or connecting to the node by relaying a web server; an instance bus configured to exchange data received from the nodes between instances; and an instance pool configured to process data received from at least two of the nodes using profiles and processes provided with respect to the nodes, in interaction with one instance.

According to still another aspect of the present invention, there is provided a service providing method, including: receiving data by connecting to at least one physical node over a wired/wireless network; managing at least one process and a profile provided with respect to at least one of a process node deployed in a process form and the physical node, and connecting the received data or data transferred from the process node to at least one instance using the profile and the at least one process; and providing a result of the processing to a user.

According to embodiments of the present invention, it is possible to manage different devices or various services through linkage or convergence therebetween and to provide an integrated service in an IoT environment, a WoT environment, or a WoO environment.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a service providing method when a device includes an embedded web server according to the related art;

FIG. 2 is a diagram illustrating a service providing method when a manufacturer provides a separate online web server according to the related art;

FIG. 3 is a diagram illustrating an example of an entire system configuration for instance hosting according to an embodiment of the present invention;

FIG. 4 is a block diagram illustrating an example of an internal configuration of an instance hosting gateway according to an embodiment of the present invention;

FIG. 5 is a block diagram illustrating an example of a network adaptor according to an embodiment of the present invention;

FIG. 6 is a block diagram illustrating an example of an instance manager according to an embodiment of the present invention;

FIG. 7 is a block diagram illustrating an example of an instance application server according to an embodiment of the present invention;

FIG. 8 is a diagram illustrating an example of an instance hosting platform according to another embodiment of the present invention;

FIG. 9 is a block diagram illustrating an example of an internal configuration of an instance hosting platform according to another embodiment of the present invention;

FIG. 10 is a diagram illustrating an example of a process of creating and using an Internet of Things (IoT) profile according to an embodiment of the present invention;

FIG. 11 is a flowchart illustrating an example of a method of setting an open Application Program Interface (API) for external exposure according to an embodiment of the present invention;

FIG. 12 is a flowchart illustrating an example of a process of deploying an IoT profile according to an embodiment of the present invention; and

FIG. 13 is a flowchart illustrating an example of a process of deploying an IoT process according to an embodiment of the present invention.

### DETAILED DESCRIPTION

Reference will now be made in detail to exemplary embodiments of the present invention, examples of which are illustrated in the accompanying drawings, wherein like reference numerals refer to like elements throughout. Exemplary embodiments are described below to explain the present invention by referring to the figures.

Hereinafter, embodiments of the present invention are described in detail with reference to the accompanying drawings.

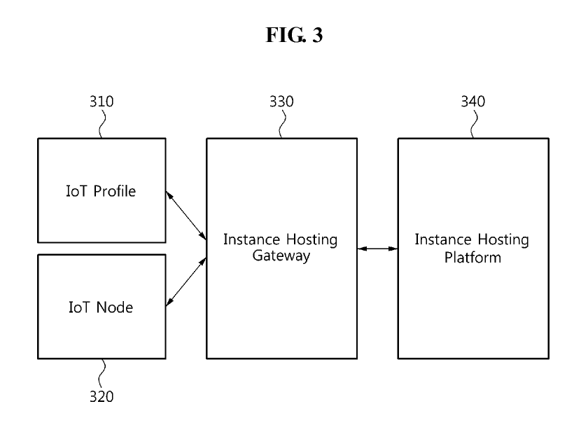

FIG. 3 is a diagram illustrating an example of an entire system configuration for instance hosting according to an embodiment of the present invention. An Internet of Things (IoT) profile 310, an IoT node 320, an instance hosting gateway 330, and an instance hosting platform 340 are illustrated in FIG. 3.

The IoT profile 310 may refer to information on the IoT node 320 that is provided online from a manufacturer or a developer of the IoT node 320. For example, the IoT profile 310 may refer to an eXtensible Markup Language (XML) file that is created when the manufacturer or the developer processes information on the IoT node 320 based on a predefined XML scheme, in order to minimize the inconvenience of a user having to manually input data to the instance hosting gateway 330.

The IoT profile 310 may include a description about the IoT node 320 and an identifier (ID) of a process in which an operation of the IoT node 320 is described. For example, a process may be provided online using a separate file, such as extension ‘js’ file and an ID of the process may be a URL indicating a location of the file. The following Table 1 shows an example of information that may be included in the IoT profile 310.

TABLE 1

| Name | Description | Note |
|---|---|---|
| IoTProfileID | A unique URL | Expressed in |
| | corresponding | a URI format. |
| | to a location of | |
| | an IoT profile | |
| IoTProfileVer | A version of an IoT Profile | Expressed in a |
| | | form of ‘V’ + |
| | | ‘number’. |
| IoTProfileDesc | A description of an IoT | |
| | Profile | |
| IoTInput | An input value of an IoT | Data support format |
| | Node (not required | JSON |
| | for an instance node | XML |
| | that does not provide an | |
| | input function), and | |
| | information used to | |
| | create RESTful API | |
| IoTOutput | An output value of an IoT | |
| | Node and information | |
| | used to create RESTFUL API | |
| IoTProcessID | A process ID of an IoT Node | Expressed in |
| | | a URI format. |

The IoT node 320 may correspond to a thing in an IoT environment, such as a sensor device, and may provide ID information of the IoT node 320, such as ‘IoTNodeID’. When the IoT node 320 is a non-constraint (NC) node such as a smart device, the IoT node 320 may directly provide the IoT profile 310.

For clarity of description, FIG. 3 illustrates a single IoT node 320 and a single IoT profile 310 about the IoT node 320. However, a plurality of IoT nodes and a plurality of IoT profiles about the plurality of IoT nodes may be used in an IoT environment. Also, a plurality of IoT profiles may be provided with respect to a single IoT node.

An IoT node and an instance may be provided in various forms, such as 1:1, 1:N, and N:M. Also, an instance may be provided in a form of a process regardless of an absence of a physical IoT node, and may be created and linked through linkage between processes, instead of being linked to a predetermined device such as a mashup process. For example, even though an instance is not connected to a separate IoT node, an instance may be created in the instance hosting gateway 330 by deploying and executing a predetermined process in the instance hosting gateway 330. In the present specification, an example of connecting, to a personal instance, and thereby processing a message received from an IoT node through communication between instance hosting gateways according to embodiments of the present invention. However, as described above, at least one IoT node may be present in a form of a process, for example, a process node, instead of being a physical device.

Further, a process of receiving information from a plurality of sensors without using a physical device, such as a sensor device or an actuator, and providing only a linkage function with another web service or application online may be provided. For example, in the case of a service that provides a predetermined result by analyzing information of sensors or state information of a predetermined application used by a user, a separate processing environment may be required to run the service. In this example, an instance hosting gateway according to embodiments of the present invention may also provide the processing environment.

Referring to FIG. 3, the instance hosting gateway 330 may connect, to a personal instance, and thereby process a message received from the IoT node 320, and may be linked to, for example, interact with an external service in response to a service request. The instance hosting gateway 330 may be provided to an access point (AP) environment for the IoT node 320. For example, the instance hosting gateway 330 may include an instance application server portion in which the instance hosting gateway 330 is included in an AP and operates as a web application server (WAS) and a portion in which the instance hosting gateway 330 is included in an AP in a form of software, hardware, or a combination of software and hardware, for example, a module included in an operating system (OS) of the AP in a form of software and a module included in a form of hardware for communication with the IoT node 320.

For example, the instance hosting gateway 330 may be included in an AP installed in a predetermined space, for example, a house, and may serve to receive and process data by communicating with things, for example, IoT nodes, included in the predetermined space and may serve to provide a linkage service with an external service.

Here, when the new IoT node 320 is found, the instance hosting gateway 330 may download and deploy the IoT profile 310. For example, a user may input a location of an XML file corresponding to the IoT profile 310 into the instance hosting gateway 330, and the instance hosting gateway 330 may download and install the XML file based on the input location.

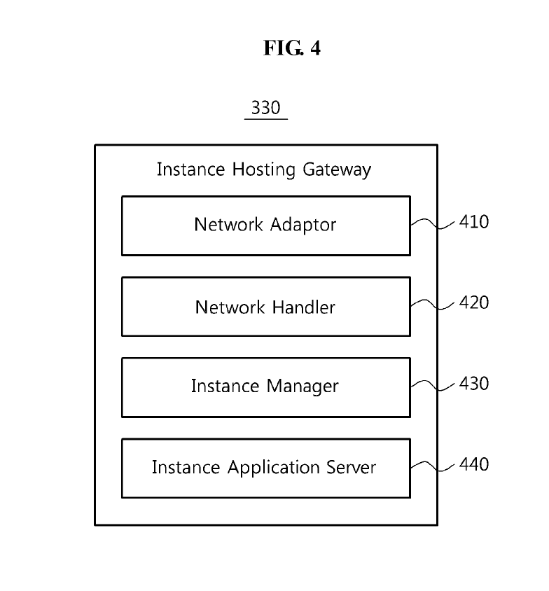

The instance hosting gateway 330 is described in more detail with reference to FIGS. 4 through 7.

The instance hosting platform 340 may provide a mashup function and a mutual linkage function between instances. For example, the instance hosting gateway 330 may provide, to an outside, a function to be provided in an API format in response to a request of a user or a service and thereby communicate with the instance hosting platform 340 for a linkage, for example, an interaction with an external service. Herein, the terms “interact/interaction” and “link/linkage” may be interchangeably used throughout.

FIG. 4 is a block diagram illustrating an example of an internal configuration of an instance hosting gateway according to an embodiment of the present invention. Referring to FIG. 4, the instance hosting gateway 330 according to the present embodiment may include a network adaptor 410, a network handler 420, an instance manager 430, and an instance application server 440.

The network adaptor 410 may provide a function of physically connecting to an IoT node in a wired or wireless manner based on a network interface standard supported by the instance hosting gateway 330. For example, the network adaptor 410 may provide an adaptor function for various types of network interactions, such as ZigBee, Bluetooth, Z-wave, Ethernet, a wireless local area network (WLAN) such as wireless fidelity (Wi-Fi), a universal serial bus (USB), and the like, and may provide an additional message parsing function for processing a message based on each network interface standard.

In particular, in an IoT environment, IoT nodes may use various message formats based on the respective characteristics. Accordingly, in the case of using a near field network interface technology such as ZigBee, Bluetooth, and Z-wave, the network adaptor 410 may further provide a function of structuralizing message data received from the IoT nodes to be suitable for an instance-by-instance format, based on an individual network interface characteristic.

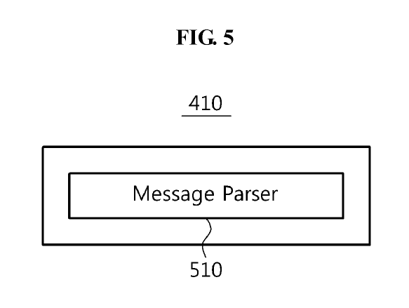

The network adaptor 410 is described in more detail with reference to FIG. 5.

The network handler 420 may transfer, to the instance manager 430, a message received from the network adaptor 410. Also, when the network adaptor 410 uses ZigBee, the network handler 420 may serve to add an instance identifier (ID) assigned by a system to a message value structuralized to be suitable for an instance-by-instance format.

The instance manager 430 refers to a module in charge of a key function for instance hosting and may provide a function of deploying an IoT file and a process, and may also serve to link a message of each of individual IoT nodes using an instance and logging each of processes.

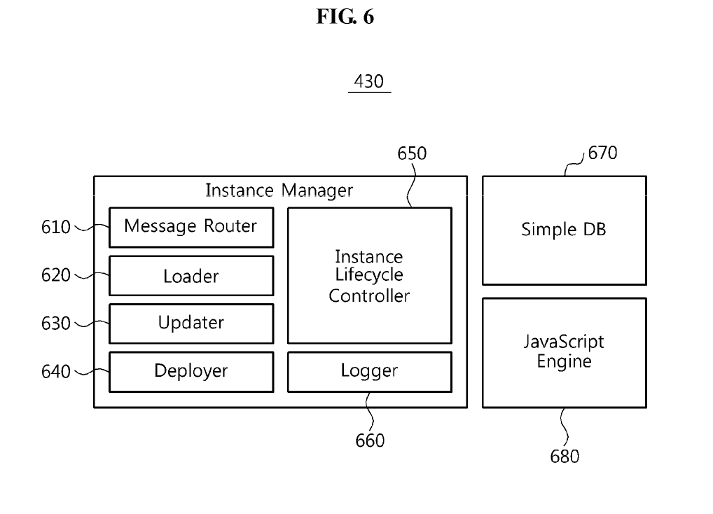

The instance manager 430 is described in more detail with reference to FIG. 6.

The instance application server 40 may perform a web application server function of the instance hosting gateway 330. Here, functions provided via the instance hosting gateway 440 may be provided to a web interface.

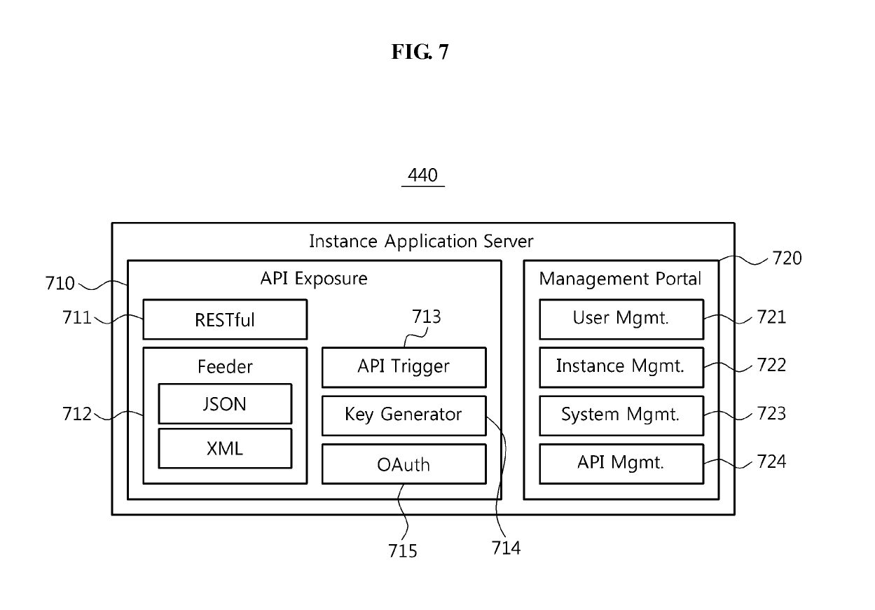

The instance application server 440 is described in more detail with reference to FIG. 7.

FIG. 5 is a block diagram illustrating an example of the network adaptor 410 according to an embodiment of the present invention. The network adaptor 410 according to the present embodiment may provide an adaptor function for various types of network interactions, such as ZigBee, Bluetooth, Z-wave, Ethernet, a WLAN such as Wi-Fi, a USB, and the like. Also, the network adaptor 410 may provide a function of classifying a message for each interface and for each apparatus within an interface and thereby guaranteeing the integrity of received data. The network adaptor 410 may include a message parser 510 configured to provide a message parsing function for processing a message based on each network interface standard.

The message parser 510 may be used to obtain structure information of a message connected to a personal instance during an instance deployment process. Here, the message parser 510 may parse a message based on a message format provided from an individual terminal device, for example, an IoT node. For example, different message formats may be used between devices using the same ZigBee network interface.

FIG. 6 is a block diagram illustrating an example of the instance manager 430 according to an embodiment of the present invention. The instance manager 430 according to the present embodiment may include a message router 610, a loader 620, an updater 630, a deployer 640, an instance lifecycle controller 650, and a logger 660. Also, depending on necessity, the instance hosting gateway 330 of FIG. 4 may further include a simple database (DB) 670 and a JavaScript engine 680.

The message router 610 may serve to route a message requested from the network handler 420 or the instance application server 440 of FIG. 4. Here, all the transactions of the message router 610 may be logged.

The loader 620 may serve to call a personal instance when processing a process for each instance. Also, the loader 620 may provide a call function with respect to instances that are to be autonomously called based on a timer. For example, when calling an instance process, the loader 620 may provide a function of calling the JavaScript engine 680 by matching a method of an individual process that is to be called based on received data. To this end, the loader 620 may provide a function of determining a call method for each message parameter.

The updater 630 may serve to download information on an IoT profile and a process present outside to the instance hosting gateway 330.

The deployer 640 may serve to parse information on the IoT profile and register process information to the instance manager 430. Individual IoT profile and process information may be formally used as an instance hosting service through a deployment process.

The instance lifecycle controller 650 refers to a module configured to provide a function of managing a lifecycle of an instance, and may provide a function of controlling the loader 620, the updater 630, and the deployer 640. For example, the instance lifecycle controller 650 may control a function of the instance manager 430 and may provide a contact point function with an instance management unit, which is described below.

The logger 660 may provide a function of logging application operation information and input/output of data occurring in the instance manager 430.

The DB 670 may store data of an IoT node.

The JavaScript engine 680 may process JavaScript. For example, an instance process of an IoT node may be processed based on JavaScript syntax, and may be used as an independent programming language, which differs from a web environment script executed on a web. Here, the JavaScript engine 680 may be used to process JavaScript syntax of the process. As another example, each function of the instance application server 440 may operate based on JavaScript.

FIG. 7 is a block diagram illustrating an example of the instance application server 440 according to an embodiment of the present invention. Referring to FIG. 7, the instance application server 440 according to the present embodiment may include an API exposure unit 710 and a management portal 720.

The API exposure unit 710 may serve to provide a function provided from the instance hosting gateway 330 to an outside in an API form. Referring to FIG. 7, the API exposure unit 710 may include a RESTful management unit (RESTful) 711 (representational state transfer), a feeder 712, an API trigger 713, a key generator 714, an authenticator (OAuth) 715.

The RESTful management unit 711 may serve to provide an input value and an output value of an IoT node instance to an interface of the RESTful management unit 711 based on information on an IoT profile.

The feeder 712 may provide the output value of the IoT node instance in a feed form, based on information on the IoT profile. Here, a format provided to be in the feed form may use at least one of a JavaScript Object Notation (JSON) format and an XML format.

The API trigger 713 may provide a function of triggering an external API such as a 3^{rd} party API. When a message includes an API triggering function based on a service characteristic of an instance, the API trigger 713 may push the message to a corresponding API.

The key generator 714 may provide a key generation function of controlling an access authentication for an interaction with external services.

The authenticator 715 may provide an authentication function for an interaction with external services. For example, the authenticator 715 may perform an authentication on external services using a key generated by the key generator 714.

The management portal 720 may provide a function used when a user controls a function of the instance hosting gateway 330 via a web or an application. Referring to FIG. 7, the management portal 720 may include a user management unit 721, an instance management unit 722, a system management unit 723, and an API management unit 724.

The user management unit 721 may provide a user account managing function, for example, a user interface, in a web form.

The instance management unit 722 may provide an instance managing function, for example, a user interface, in a web form.

The system management unit 723 may provide a system managing function, for example, a user interface, in a web form.

The API management unit 724 may provide an API managing function, for example, a user interface, in a web form.

As described above, at least a portion of constituent elements configuring the instance hosting gateway 330 according to the present embodiment may be configured in a software form. In this case, at least the portion may be provided in a form of an application including a plurality of modules. A file distribution system for providing a file may be provided to install the application. According to an embodiment, the application may include a module configured to receive data from a plurality of nodes by connecting to the plurality of nodes over a wired/wireless network, and a module configured to process data received from at least two of the plurality of nodes using profiles and processes provided with respect to the plurality of nodes, in interaction with a single instance. According to another embodiment, the application may be installed in an access point (AP) to which the plurality of nodes is connected. The modules may vary based on constituent elements that are configured in a software form among the constituent elements configuring the instance hosting gateway 330.

Also, a service providing method including operations performed by the instance hosting gateway 330 according to the present embodiment may be provided. For example, the service providing method may include receiving data from a plurality of nodes by connecting to the plurality of nodes over a wired/wireless network, processing data received from at least two of the plurality of nodes using profiles and processes provided with respect to the plurality of nodes, in interaction with a single instance, and providing a result of the processing to a user via a web or an application. According to another embodiment, the service providing method may include calling a personal instance for processing a process for each instance, and providing a function of managing a lifecycle of the personal instance.

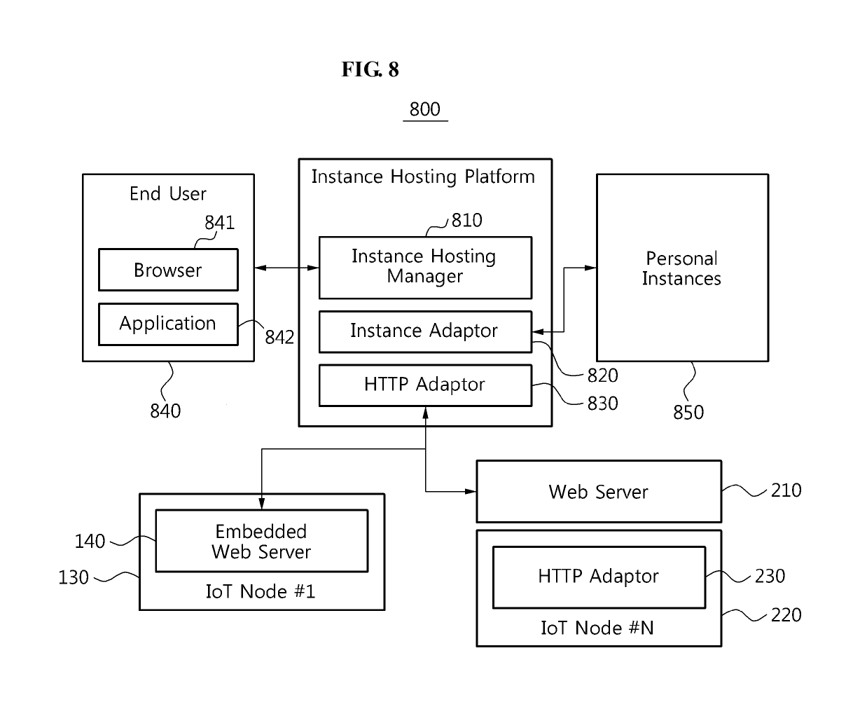

FIG. 8 is a diagram illustrating an example of an instance hosting platform according to another embodiment of the present invention. The instance hosting platform 340 of FIG. 3 is configured to receive an API online from the instance hosting gateway 330 that is applied to an AP in a predetermined space and to process the API, and thereby to provide an interaction function between instances and a mashup function. An instance hosting platform 800 of FIG. 8 may provide an online service in a form in which the instance hosting gateway 330 and the instance hosting platform 340 of FIG. 3 are combined.

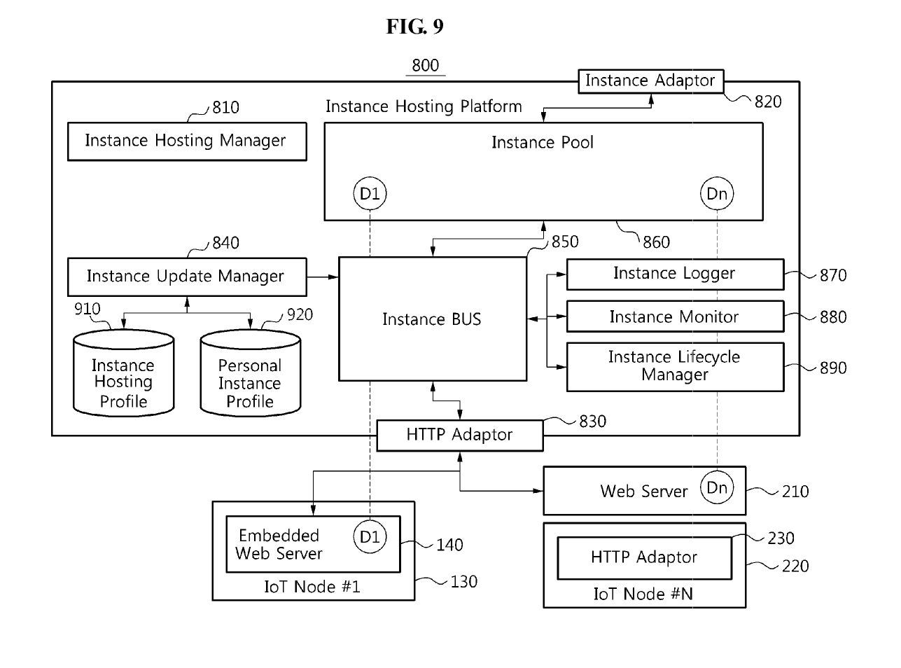

Referring to FIG. 8, the instance hosting platform 800 may include an instance hosting manager 810, a first network adaptor 820, for example, a HTTP adaptor, and a second adaptor 830, for example, a HTTP adaptor. Other constituent elements included in the instance hosting platform 800 are described in more detail with reference to FIG. 9.

The instance hosting manager 810 may provide a function for a connection to an end user. The end user may refer to a terminal used by users of IoT nodes, and may communicate with the instance hosting platform 800 via at least one application (for example, Application 842) and at least one web browser (for example, Browser 841) installed in the terminal (for example, End user 840).

The first network adaptor 820 may provide a function for a connection to personal instances 850 indicating a variety of external services, such as a social network service (SNS), a map service, and a weather service. For example, the first network adaptor 820 may be used for a connection to servers configured to provide a variety of external services. Instance information according to an external service may be present in an individual form for each service.

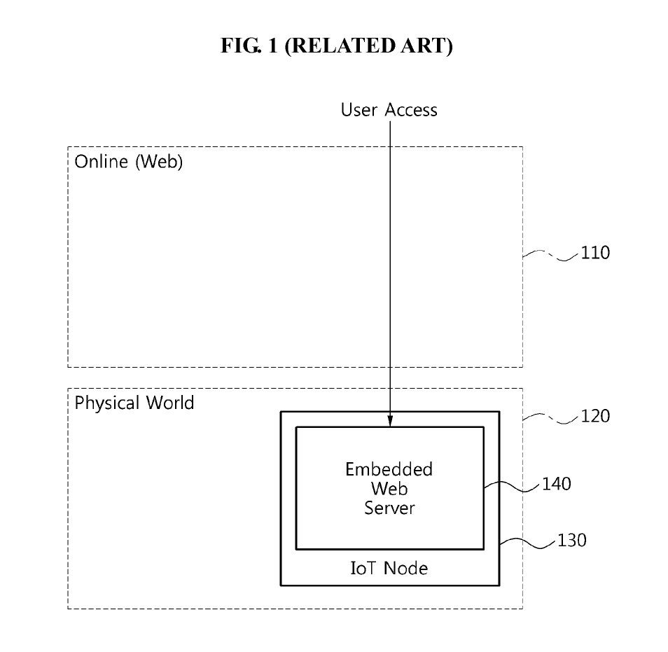

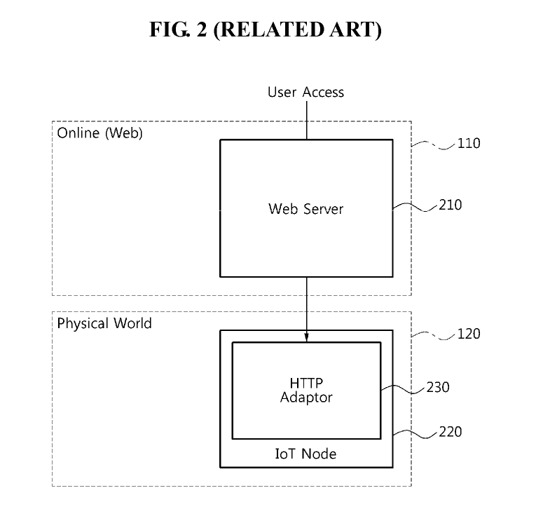

The second network adaptor 830 may provide a function for a connection to various IoT nodes. For example, the instance hosting platform 800 may provide a service in an interaction with existing IoT nodes configured to provide a service in various form, such as the IoT nodes 130 and 220 of FIGS. 1 and 2.

FIG. 9 is a block diagram illustrating an example of an internal configuration of the instance hosting platform 800 according to another embodiment of the present invention. The instance hosting platform 800 according to the present embodiment may further include an instance update manager 840, an instance bus 850, an instance pool 860, an instance logger 870, an instance monitor 880, and an instance lifecycle manager 890 in addition to the aforementioned constituent elements of FIG. 8.

The instance update manager 840 may serve to download, update, store, and manage an instance hosting profile 910 and a personal instance profile 920. The instance hosting profile 910 may correspond to the aforementioned IoT profile, and the personal instance profile 920 may include a profile about the personal instances described above with reference to FIG. 8. The profile about the personal instances may be provided by a developer or a provider that provides an external service.

The instance bus 850 may provide a message bus function between instances. For example, in response to a request of the web server 210 communicating with the IoT node 220, data ‘D1’ of the IoT node 130 stored in the instance pool 860 may be provided via the instance bus 850. Also, the instance bus 850 may also provide a mutual authentication function between instances.

The instance pool 860 may refer to an execution environment of instances, and may also refer to a space in which instances are executed and personal processes are deployed. Additionally, functions of loading and storing an instance and managing instances and the instance pool 860 may be provided. The instance pool 860 may also process an instance in a wakeup form using a timer and the like, based on a characteristic of the instance. Data about various IoT nodes may be transferred to the instance pool 860 via the instance bus 850. Accordingly, data transmitted from IoT nodes using heterogeneous or different protocols may also be used to provide a service through an interaction and convergence therebetween.

The instance logger 870 may process logging of a message associated with an instance.

The instance monitor 880 may monitor whether the instance normally runs.

The instance lifecycle manager 890 may manage a period or repetitive running function of the instance.

Also, a service providing method including operations performed by the instance hosting platform 800 according to the present embodiment may be provided. For example, the service providing method may include receiving data through a node including an embedded web server or a node connected by relaying a web server, exchanging data between instances, and processing data received from at least two of a plurality of nodes using profiles and processes provided with respect to the plurality of nodes, in an interaction with a single instance. According to another embodiment, the service providing method may further include downloading and managing profiles and personal instance profiles, and connecting to an external service including a web service using a personal instance profile.

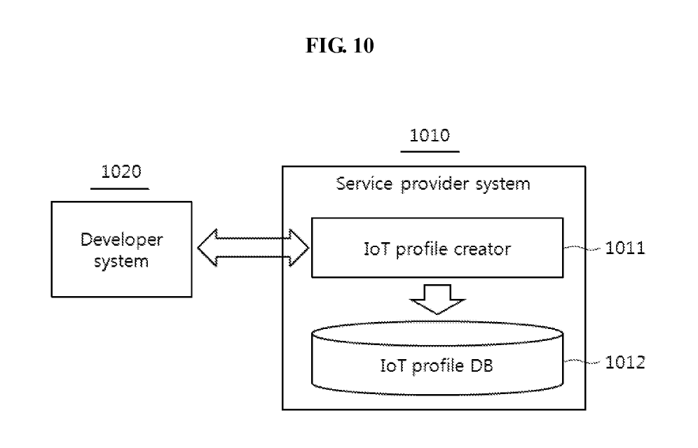

FIG. 10 is a diagram illustrating an example of a process of creating and using an IoT profile according to an embodiment of the present invention. FIG. 10 illustrates a service provider system 1010 and a developer system 1020.

The service provider system 1010 may refer to a system of a service provider that provides a service of an instance hosting gateway, and the developer system 1020 may refer to a system used by a developer or a development company of an IoT node. For example, the service provider system 1010 may be a server provided from the service provider to create and manage an IoT profile. The developer system 1020 may be a client terminal used by the developer to access a website provided from the server.

The developer may access a website provided from the service provider system 1010 using the developer system 1020, and may input information on an IoT node.

Here, the service provider system 1010 may create an IoT profile based on information on an IoT node received via a website. For example, the service provider system 1010 may include an IoT profile creator 1011 configured to create an IoT profile based on the received information on the IoT node and an XML schema definition (XSD).

The created IoT profile may be stored in the service provider system 1010 and thereby managed. For example, the service provider system 1010 may include an IoT profile DB 1012. The created IoT profile may be stored in the IoT profile DB 1012 and thereby managed. The IoT profile DB 1012 may be configured as, for example, a Universal Description Discovery and Integration (UDD) that is a storage for registering and searching for a web service. Also, the created IoT profile may be provided to the developer system 1020.

Information on the IT node provided from the developer may include information as expressed by the following Table 2.

TABLE 2

| Element | Description |
|---|---|
| IoT_Profile | Root tag |
| Profile | A plurality of profiles is settable on a single IoT profile. |
| url | Information on a URL in which a corresponding IoT |
| | file is located |
| Display_name | A name representing a profile during a service |
| | deployment process |
| Product_Name | A product name (IoT node name) described by an |
| | IoT profile |
| Product_image | An image of a product described by an IoT profile |
| | (provided to read image information together when |
| | loading a profile) |
| description | Description about an IoT node |
| schema | A scheme about an IoT profile |
| created | A created date of an IoT profile |
| version | A version of an IoT profile |
| creator | A creator of an IoT profile |
| Process_url | A process URL connected to an IoT profile |
| datastream | Tag about a datastream produced by an IoT node |
| | Various datastreams in an input/output form are |
| | present in a single sensor. |
| id | A unique value to identify a sensor datastream |
| name | A name to identify a sensor datastream |
| units | A unit to be used by a datastream |
| Min_value | A minimum value (a numerical number indicated using a |
| | sign) |
| Max_value | A maximum value (a numerical number indicated using a |
| | sign) |

Information on an IoT node to be provided from a developer may be prepared based on a predetermined text creation rule, for example, an IoT node schema and thereby provided. As described above, the service provider system 1010 may provide a function of creating an IoT profile based on information on the IoT node, to be in a web service form. For example, the IoT profile may be created based on information on the IoT node, expressed by Table 2, and may include basic description and interface information of the IoT node.

The created IoT profile may be distributed via the IoT profile DB 1012, or may be uploaded to a website of the developer and thereby be distributed via the website of the developer. Also, as described above, when the IoT node is a non-constraint (NC) node such as a smart device, the IoT profile may be included in the IoT node and the IoT node may directly provide the IoT profile.

Hereinafter, a method of recognizing, by an instance hosting gateway, information provided from an individual IoT node as service information based on the IoT profile according to embodiments of the present invention is described. As described above with reference to FIGS. 6 and 7, the instance hosting gateway may download information on an IoT profile and a process present outside (see the updater 630 of FIG. 6). Here, the instance hosting gateway may provide an input value and an output value of an IoT node instance via an interface, for example, a RESTful interface, of a RESTful management unit based on information on the IoT profile.

In the case of general content/data aggregation systems, a user may need to set an externally exposed API directly or using a wizard form, and may also need to designate naming of an individual interface and a data source to be displayed.

The instance hosting gateway according to embodiments of the present invention may provide a function of creating an API to read an IoT profile associated with RESTful interface creation and then automatically expose a datastream value. For example, the API exposure unit 710 configured to serve to provide a function provided from the instance hosting gateway to an outside in an API form is described above with reference to FIG. 7.

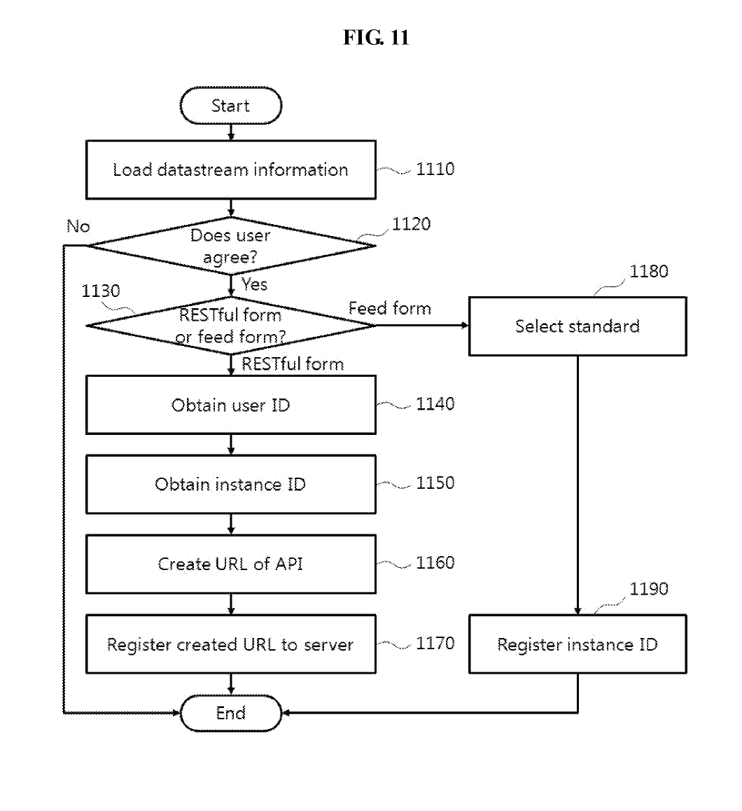

FIG. 11 is a flowchart illustrating an example of a method of setting an open API for external exposure according to an embodiment of the present invention. A method of creating a RESTful interface according to the present embodiment may be performed by an instance hosting gateway according to embodiments of the present invention or an instance application server included in the instance hosting gateway.

In operation 1110, the instance hosting gateway may load datastream information. Here, the datastream information may be raw datastream information created by an IoT node and thereby received. When datastream information to be loaded is absent, a process of setting the open API may be terminated.

In operation 1120, the instance hosting gateway may verify whether a user agrees. A function with respect to APIs for externally exposing registered instances may be provided in a RESTful form. API creation information may be provided by obtaining the agreement, that is, the consent of a user based on information on an IoT profile and a personal instance. Accordingly, the instance hosting gateway may need to verify whether the user agrees on whether to provide API creation information. When the user disagrees on providing the API creation information, the process of setting the open API may be terminated.

In operation 1130, the instance hosting gateway may select a RESTful form or a feed format. When the RESTful form is selected, operation 1140 may be performed. When the feed form is selected, operation 1180 may be performed.

In the RESTful form, raw datastream information created by the IoT node may be directly provided to an outside via an API web interface. A process of providing the raw datastream information may proceed based on a selection of the user when deploying an instance of the IoT node. To this end, the instance may individually include interface information for external exposure, and the instance hosting gateway may read the included interface information when deploying the instance and may provide the read interface information to a user. For example, when displaying a RESTful interface, a utilization form of data or available data may vary for each personal instance and thus, a new address system may be used. According to the present embodiments, in order to provide the RESTful interface, it is possible to create a description document of reading IoT profile and process information and providing the RESTful interface in an automated format, and to create a URL of the description document.

In operation 1140, the instance hosting gateway may obtain a user ID. For example, an actual user owning a corresponding instance may be verified for each instance via the management portal 720 of FIG. 7. In this case, the instance hosting gateway may obtain a user ID of the verified user.

In operation 1150, the instance hosting gateway may obtain an instance ID. The instance ID may be assigned to each message received from the IoT node, or each set of datastream information.

In operation 1160, the instance hosting gateway may create a URL of the API. The instance hosting gateway according to the present embodiments may create a description document of reading IoT profile and process information and providing the RESTful interface in an automated format, and may create a URL of the description document. Here, the description document refers to a description document for an open API to be provided to an outside. The following Table 3 shows an example of the created URL.

TABLE 3
http://$userID$.instancehosting.com/instanceId/$instanceID$/description.html
* Parameter values are divided using ‘$’.

In operation 1170, the instance hosting gateway may register the created URL to a server. For example, when information associated with calling a RESTful interface of a predetermined instance is required for an external 3^{rd} party service, the instance hosting gateway may provide basic information for relevant RESTful call in a webpage format when providing an API. The basic information may be provided through the URL in a form of the description document of providing the RESTful interface. Accordingly, the instance hosting gateway may register the created URL to the server and thus, the external 3^{rd} party service may refer to the description document.

In operation 1180, the instance hosting gateway may select a standard. When the feed form is selected, data log of an IoT node stored by personal instances may be formatted and thereby provided in a JSON or an XML format. For example, datastream information of the IoT node may be stored as data log in association with at least one instance that is associated with the IoT node. In operation 1180, the instance hosting gateway may determine whether to provide the data log using JSON or XML. In this case, a function that enables the user to set a publication for each field related to the data log may be provided. A feed may include interface information for providing a standard, for example, a JSON standard, required when providing available information in a datastream or feed form for each interface. Here, feed providing location information may be created for each set of unique information of a personal instance. The following Table 4 shows an example of a basic data value in a JSON based feed form.

TABLE 4

| ID | Value | Description |
|---|---|---|
| Status | String | Represents information on presence/absence |
| | | of running of a corresponding feed and |
| | | thus, includes running, suspend, and stop |
| | | as values. |
| title | String | Title of a corresponding feed |
| Feed | URL | Unique URL of a corresponding feed |
| tags | String | Tag information of a corresponding feed |
| description | String | Description of a of a corresponding feed |
| created | String | A created date of a corresponding feed |
| version | String | Version information. |
| creator | URL | Creator (user ID) |
| updated | Date | Date when a message is finally update |
| id | Number | Unique feed ID |
| datastreams | | In a case in which a value of data is |
| (current_value) | | provided in a datastream form |
| at | String | Time + GeoLocation |
| | | “at”:“2012-12-14T05:25:57.529014Z”, |
| unit | String | Unit information including label information |
| max_value | String | A maximum value of data |
| min_value | String | A minimum value of data |

In Table 4, a field indicated by an under bar may represent repeated information.

In operation 1190, the instance hosting gateway may register the instance ID. For example, the instance hosting gateway may include a feeder configured to provide an output value of the IoT node instance in the feed form, based on information on the IoT profile. Here, the feeder may correspond to the feeder 712 of FIG. 7. In operation 1190, the instance hosting gateway may register the instance ID to the feeder, and the data log may be formatted based on a predetermined standard using the registered instance ID and thereby be provided to an outside.

Also, according to an embodiment of the present invention, in response to a request for the RESTful form, it is possible to support a function of avoiding a security hole. In the instance hosting gateway according to the present embodiment, RESTful may provide an authentication function using two types, a “key” type and an “OAuth” type.

Initially, when the RESTful interface is requested in the key type, a URL of an API may be configured as expressed by the following Table 5.

TABLE 5

http://$userID$.instancehosting.com/instanceId/$instanceID$/key/
$tokenKey$/start/$startingpoint$/display/$requestCount$

Also, the OAuth type may proceed based on a general OAuth process. The instance hosting gateway may provide a function corresponding to a role of a service provider. When the RESTful interface is requested in the “OAuth” type, a URL of an API may be configured as expressed by the following Table 5.

TABLE 6

http://$userID$.instancehosting.com/instanceId/$instanceID$/start/
$startingpoint$/display/$requestCount$

The authentication procedure has been performed through “OAuth” and thus, key information is not requested in a separate URL form.

Terms used in Table 3, Table 5, and Table 6 are examples and thus, may be expressed by the following Table 7.

TABLE 7

| URL | | |
|---|---|---|
| Parameter | Description | Note |
| userID | A user ID registered to an | |
| | instance hosting gateway system | |
| instanceID | An instance ID running on an | |
| | instance hosting gateway | |
| Key | A key issued to a user | In the case of “OAuth” |
| | | authentication, a separate |
| | | key value is not input on an |
| | | URL and an address portion |
| | | is also excluded. |
| Start | A start point of requested data | A data value or log is |
| | | connected based on a “1” |
| | | count unit. |
| display | Counts of requested data | 1 to 10,000 counts of |
| | | requested data are |
| | | supported. |

The process of creating and using the IoT file and the method of setting the open API for external exposure are described above with reference to FIGS. 10 and 11. Hereinafter, a process of deploying an IoT profile and an IoT process is described. For example, a method of receiving, by an instance hosting gateway, data created in an individual message format and an interface format by various IoT nodes, for example, data sensed by the IoT nodes, and effectively biding the received data with processes is described.

The IoT node developer or development company may develop a product by designing an IoT node, may create an IoT profile of the IoT node, as described above with reference to FIG. 10, and may sell the developed product, for example, IoT node. Here, the IoT profile may be included in the IoT node on sales and may also be uploaded to a website associated with the IoT node developer or development company, such as a homepage of the IoT node developer or development company, and thereby provided. Also, the IoT profile may be stored in a DB of a service provider system that creates the IoT profile.

An IoT node user may purchase an IoT node and may attempt to access an AP, for example, the instance hosting gateway. Here, when a new IoT node is discovered, the instance hosting gateway may set device information of the new IoT node, which is a selective process, and may set or deploy an IoT profile of the new IoT node. Also, the instance hosting gateway may set or deploy an IoT process of the new IoT node, and may use IoT by setting an open API of the new IoT node.

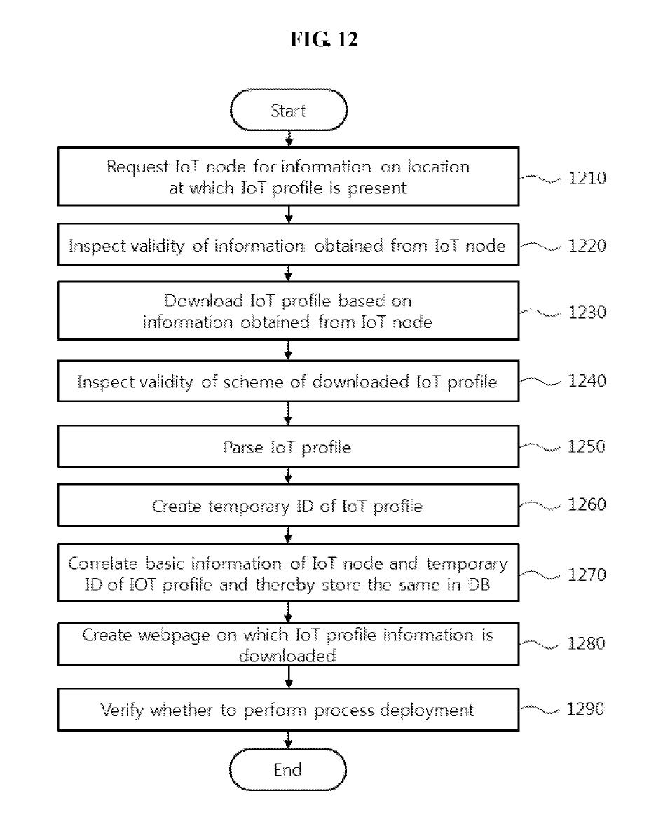

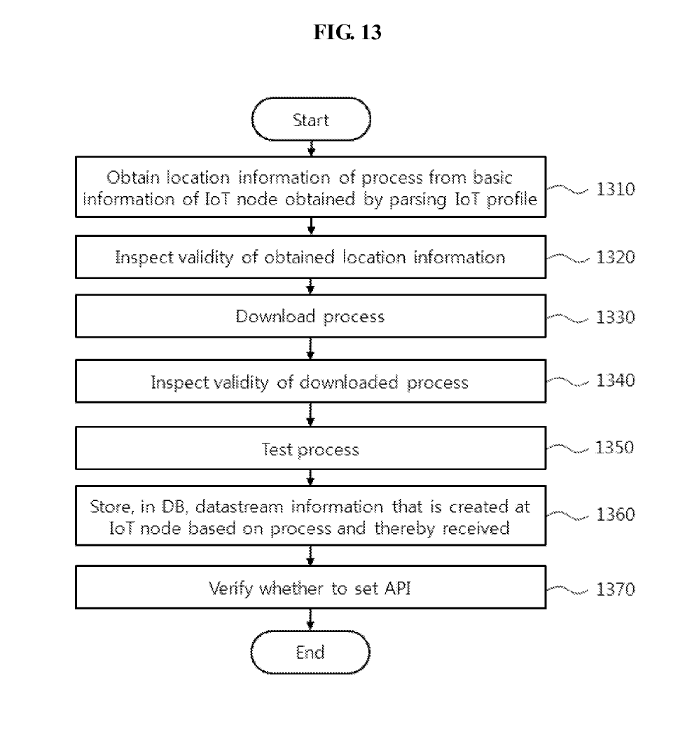

Hereinafter, a process of setting or deploying the IoT profile of the new IoT node and a process of setting or deploying the IoT process are described in more detail with reference to FIGS. 12 and 13. A method of setting the open API of the new IoT node is described above with reference to FIG. 11.

FIG. 12 is a flowchart illustrating an example of a process of deploying an IoT profile according to an embodiment of the present invention. Here, the process of deploying the IoT profile according to an embodiment of FIG. 12 may be performed by the instance hosting gateway according to embodiments of the present invention.

In operation 1210, the instance hosting gateway may request an IoT node for information on a location at which an IoT profile is present. For example, the IoT profile may be uploaded to a website of a developer or a development company, and the IoT node may include a URL of the website. When the instance hosting gateway fails in obtaining the URL, the instance hosting gateway may continuously request the IoT node for the corresponding information, or may terminate the process of deploying the IoT profile.

In operation 1220, the instance hosting gateway may inspect the validity of information obtained from the IoT node. For example, the instance hosting gateway may verify whether the IoT profile of the IoT node is present at the URL provided from the IoT node. When the corresponding information is invalid, the instance hosting gateway may request the IoT node for the corresponding information again, or may terminate the process of deploying the IoT profile.

In operation 1230, the instance hosting gateway may download the IoT profile based on information obtained from the IoT node.

In operation 1240, the instance hosting gateway may inspect the validity of a scheme of the downloaded IoT profile. For example, the IoT profile may refer to an XML file in which information on the IoT node is created by a manufacturer or a developer based on a predefined XML scheme in order to minimize the inconvenience that the user needs to manually input data to the instance hosting gateway. In this case, the instance hosting gateway may verify whether the IoT profile is appropriately created based on the predefined XML scheme in operation 1240.

In operation 1250, the instance hosting gateway may parse the IoT profile. The instance hosting gateway may obtain basic information on the IoT node by parsing the IoT profile. For example, the basic information on the IoT node may include an ID for identifying the IoT node, an external web service location URL of the IoT profile, a title, a description, a scheme, a version, a created date, and a creator, for example, information on a company, a developer, and the like, of the IoT profile, location information of the IoT process, for example, a URL in which the IoT process is stored, an input value/output value of the IoT node, user ID information, and the like.

In operation 1260, the instance hosting gateway may create a temporary ID of the IoT profile.

In operation 1270, the instance hosting gateway may correlate basic information of the IoT node and the temporary ID of the IoT profile and thereby store the same in a DB.

In operation 1280, the instance hosting gateway may create a webpage on which IoT profile information is loaded.

In operation 1290, the instance hosting gateway may verify whether to perform a process deployment. When the process deployment is determined to be performed, a process of FIG. 13 may be performed. Conversely, when the process deployment is determined not to be performed, the process of deploying the IoT profile may be terminated.

FIG. 13 is a flowchart illustrating an example of a process of deploying an IoT process according to an embodiment of the present invention. The process of deploying the IoT process according to an embodiment of FIG. 13 may be performed by the instance hosting gateway according to embodiments of the present invention.

In operation 1310, the instance hosting gateway may obtain location information of a process from basic information of an IoT node obtained by parsing an IoT profile. For example, the location information of the process may be address information on a physical location of a process file within a system.

In operation 1320, the instance hosting gateway may inspect the validity of the obtained location information.

In operation 1330, the instance hosting gateway may download the process.

In operation 1340, the instance hosting gateway may inspect the validity of the downloaded process. For example, the instance hosting gateway may inspect the validity of the downloaded process by comparing an input value/output value of the process and an input value/output value of the IoT node in the basic information stored in a DB.

In operation 1350, the instance hosting gateway may test the process.

In operation 1360, the instance hosting gateway may store, in the DB, datastream information that is created at the IoT node based on the process and thereby received.

In operation 1370, the instance hosting gateway may verify whether to set an API. When the API is verified to be set, the instance hosting gateway may perform the method of setting the open API of FIG. 11. Here, datastream information loaded in operation 1110 may be datastream information stored in the DB in operation 1360.

As described above, the instance hosting gateway according to embodiments of the present invention may create a RESTful interface using the IoT profile, and may create relevant documents. For example, the instance hosting gateway may automatically create a URL structure.

According to embodiments of the present invention, it is possible to manage different devices or various services through linkage or convergence therebetween and to provide an integrated service in an Internet of Things (IoT) environment, a Web of Things (WoT) environment, or a Web of Objects (WoO) environment.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A service providing system comprising an instance hosting gateway, the system comprising:
a network adaptor configured to receive data by connecting to at least one physical node over a wired or wireless network; and
an instance manager configured to manage at least one process and a profile provided with respect to at least one of a process node deployed in a process form and the physical node, and to connect the received data or data transferred from the process node to at least one instance using the profile and the at least one process.

2. The system of claim 1, wherein the at least one physical node is provided to a device connected using at least one of a plurality of network interfaces.

3. The system of claim 1, wherein the instance manager comprises:
a loader configured to call a personal instance to process the at least one process for each instance; and
an instance lifecycle controller configured to provide a function of managing a lifecycle of the personal instance.

4. The system of claim 3, wherein the instance manager further comprises:
an updater configured to download information on a profile and a process present outside, and
the updater is configured to obtain location information of the profile from the at least one node, to obtain the profile based on the location information of the profile, and to obtain information on the profile based on the location information of the process of the at least one node that is included in information on the at least one node included in the profile.

5. The system of claim 4, further comprising:
a deployer configured to parse information on the profile and register information on the process,
wherein the instance manager is configured to process datastream information received from the at least one node based on information on the process.

6. The system of claim 3, wherein the instance manager further comprises:
a logger configured to log application operation information and input/output of data occurring in the instance manager;
a database configured to store data received from the physical node or data transferred from the process node; and
a JavaScript engine configured to process JavaScript syntax included in the processes.

7. The system of claim 1, further comprising:
an instance application server configured to provide a function of interacting with an external service, and to provide a user interface to a user.

8. The system of claim 7, wherein the instance application server comprises:
an application program interface (API) exposure unit configured to provide, to the external service, a function associated with processing the instance in a form of an API for an interaction with the external service; and
a management portal configured to provide, to the user, at least one of a user account managing function, an instance managing function, a system managing function, and an API managing function.

9. The system of claim 8, wherein the API exposure unit comprises:
a RESTful management unit configured to provide an input value and an output value of the instance via an interface based on profiles;
a feeder configured to provide the output value of the instance in a feed form based on the profiles; and
an API trigger configured to trigger an external API, and to transfer, to a corresponding API, a message comprising an API triggering function.

10. The system of claim 9, wherein:
the instance manager is configured to load datastream information of the at least one node, and to select one of a RESTful form and the feed form, and
when the RESTful form is selected, the RESTful management unit is configured to obtain a user identifier of a user of an instance corresponding to the datastream information and an instance identifier of the datastream information, to create a universal resource locator (URL) of an API for providing the datastream information to an outside based on the user identifier and the instance identifier, and to register the created URL to an instance hosting platform server.

11. The system of claim 7, wherein the instance application server further comprises:
a key generator configured to generate a key for controlling an access authentication for an interaction with external services; and
an authenticator configured to provide a function for authentication when interacting with the external services.

12. The system of claim 1, wherein the network adaptor comprises:
a message parser configured to parse data received based on a message format for each interwork interface or a message format for each node.

13. The system of claim 1, wherein the profile is created at a service provider server based on information provided from a developer of the at least one node, and is stored and thereby managed in an Internet of Things (IoT) profile database included in the service provider server or is provided to the developer, and
the at least one node is registered to the instance hosting gateway using the profile stored in the IoT profile database, the profile provided to the developer and thereby provided through a URL associated with the developer, or the profile provided to the developer and thereby included in the at least one node.

14. The system of claim 1, further comprising:
an IoT profile receiver configured to receive the profile of the at least one node through the at least node requesting an access, a URL associated with a developer of the at least one node, or an IoT profile database of a service provider server that creates the profile of the at least one node; and
an IoT node register configured to register the at least one node requesting the access based on the profile,
wherein the profile is created by the service provider server based on information on the at least one node provided from the developer of the at least one node and a predetermined eXtensible Markup Language (XML) schema definition.

15. A service providing system, comprising:
a first network adaptor configured to receive data from nodes by connecting to a node comprising an embedded web server or connecting to the node by relaying a web server;
an instance bus configured to exchange data received from the nodes between instances; and
an instance pool configured to process data received from at least two of the nodes using profiles and processes provided with respect to the nodes, in interaction with one instance.

16. The system of claim 15, further comprising:
an instance update manager configured to download and manage the profiles and personal instance profiles; and
a second network adaptor configured to connect to an external service comprising a web service, using the personal instance profiles.

17. A service providing method, comprising:
receiving data by connecting to at least one physical node over a wired or wireless network;
managing at least one process and a profile provided with respect to at least one of a process node deployed in a process form and the physical node, and connecting the received data or data transferred from the process node to at least one instance using the profile and the at least one process; and
providing a result of the processing to a user.

18. The method of claim 17, wherein the managing and the connecting comprises:
calling a personal instance for processing a process for each instance; and
providing a lifecycle of the personal instance.

19. The method of claim 17, wherein the profile is created at a service provider server based on information provided from a developer of the at least one node, and is stored and thereby managed in an Internet of Things (IoT) profile database included in the service provider server or is provided to the developer, and
the at least one node is registered to the instance hosting gateway using the profile stored in the IoT profile database, the profile provided to the developer and thereby provided through a URL associated with the developer, or the profile provided to the developer and thereby included in the at least one node.

20. The method of claim 17, further comprising:
receiving the profile of the at least one node through the at least node requesting an access, a universal resource locator (URL) associated with a developer of the at least one node, or an IoT profile database of a service provider server that creates the profile of the at least one node; and
registering the at least one node requesting the access based on the profile,
wherein the profile is created by the service provider server based on information on the at least one node provided from the developer of the at least one node and a predetermined eXtensible Markup Language (XML) schema definition.
